(19) United States
(12) Patent Application Publication
(10) Pub. No.: US 2026/0296443 A1
(43) Pub. Date: Oct. 1, 2026

(54) VEHICLE

(71) Applicant: AUDI AG, Ingolstadt (DE)

(72) Inventors: Johannes SIWIG, Adelshausen (DE); Daniel KEMPTNER, Ingolstadt (DE)

(21) Appl. No.: 19/633,843

(22) Filed: Mar. 30, 2026

(30) Foreign Application Priority Data
Mar. 31, 2025 (DE) 102025112451.5

(51) Int. Cl. B60W 30/184; B60W 10/04; B60W 10/11; B60W 30/188

(52) U.S. Cl. CPC B60W 30/1846; B60W 10/04; B60W 10/11; B60W 30/188; B60W 2510/102; B60W 2520/105; B60W 2710/1022

(57) ABSTRACT

A vehicle having a drive train is provided which includes a control unit that has an evaluation module that adjusts the transmission protection torque limit (M_{S}(a)) as a function of an actual acceleration of the vehicle or of an actual rotational speed gradient (a) in the drive train correlated therewith.

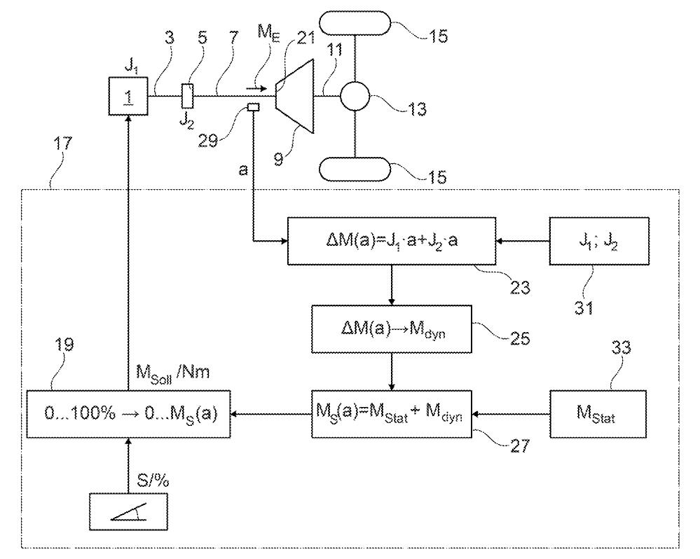

German patent application no. 10 2025 112 451.5, filed March 31, 2025, to which this application claims priority, is hereby incorporated herein by reference, in its entirety.

### BACKGROUND

### Technical Field

The disclosure relates to a vehicle with a drive train.

### Description of the Related Art

A drive train of a vehicle of a generic type has a drive unit that transmits a drive torque to the vehicle wheels via a transmission during driving operation. The drive torque is controlled via a control unit that determines a target drive torque on the basis of a driver-side setpoint input, with which the drive unit can be controlled. The target drive torque determined in the control unit is limited to a maximum transmission protection torque limit (e.g., in the event of a full load request from the driver) in order to ensure component protection in the transmission during driving operation. The problem here is that the maximum drive torque that can be provided by the drive unit is often greater than the transmission protection torque limit. In this case, the drive potential of the drive unit cannot be fully utilized, in particular in the case of a full load request from the driver.

DE 10 2018 104 821 A1 provides a system for operating a power transmission of a hybrid vehicle that has an internal combustion engine, an electric machine of a rear drive unit, an integrated starter/generator, and a transmission. In one example, an inertia torque compensation is provided to counteract inertia torque during a power-on upshift

DE 195 04 847 A1 discloses a method for controlling a torque transmission system for implementing the control method and a monitoring method for torque transmission systems.

### BRIEF SUMMARY

The disclosure provides a vehicle in which the drive potential of the drive unit can be utilized more efficiently compared to the prior art, in particular in the case of a full load request from the driver.

The disclosure relates to a vehicle having a drive train, the drive unit of which transmits a drive torque to the vehicle wheels via a transmission. A control unit of the vehicle determines a target drive torque on the basis of a driver-side setpoint input, with which the control unit controls the drive unit. In the event of a full load request from the driver, the target drive torque determined in the control unit is limited to a maximum transmission protection torque limit.

The disclosure is based on the following facts: During vehicle acceleration, a transmission input torque applied at a transmission input is less than the target drive torque with which the control unit controls the drive unit, namely by a torque difference that is made up of the actual mass moments of inertia of the rotatable drive train components that are arranged on the transmission input side and that are located upstream of the transmission in the direction of torque flow. The magnitude of these actual mass moments of inertia depends on the actual acceleration of the vehicle.

Against this background, the following measure is taken to utilize a maximum available drive potential of the drive unit more efficiently, in particular when a full load is requested by the driver: The control unit has an evaluation module that adjusts the transmission protection torque limit as a function of the actual acceleration of the vehicle or a drive train rotational speed gradient that correlates with it. This means that when there is an actual acceleration of the vehicle (i.e., of the drive train components on the transmission input side), the transmission protection torque limit is increased by the evaluation module, and when there is no such actual acceleration of the vehicle, a static transmission protection torque component is retained unchanged.

The potential of the drive units can be better utilized by dynamically adjusting the transmission protection torque limit. In particular during acceleration, the temporary increase of the transmission protection torque limit means that the drive potential of the drive unit does not remain unused. This noticeably improves the vehicle dynamics, in particular in the ranges of 0-100 km/h, 0-200 km/h, and spontaneous acceleration processes. This increases both the performance and the emotionality of the vehicle, which boosts customer appeal. At the same time, it is ensured that the transmission protection requirements are met, since the temporary increase of the torque is only used to accelerate the mass moment of inertia on the transmission input side.

In a technical implementation, the transmission protection torque limit can be summed up from the static transmission protection torque component and a dynamic transmission protection torque component. When there is no vehicle acceleration, the dynamic transmission protection torque component is zero, so that the transmission protection torque limit corresponds to the static transmission protection torque component. The dynamic transmission protection torque component can only build up when acceleration of the drive train components on the transmission input side is present. The separation into a static and a dynamic torque component allows more precise control of the transmission protection torque. This ensures that the transmission protection limit is not unnecessarily increased in steady-state phases, while additional power can be used during acceleration. This ensures an optimum balance between performance and transmission protection.

It should be emphasized that the static transmission protection torque component does not have to be fixed at a predefined value, but can be variable, for example as a function of a power limitation (speed dependency), a temperature limitation and/or a torque converter multiplication factor.

In the event of acceleration, the control unit can dimension the dynamic transmission protection torque component in such a way that the transmission input torque applied at the transmission input is less than or equal to the static transmission protection torque component, so that the transmission protection requirements are met. The static transmission protection torque component can be stored as a fixed value in the control unit and correspond to a protection torque up to which component protection in the transmission is guaranteed. This ensures that the transmission remains protected even when maximum power is required. At the same time, the intelligent adjustment of the dynamic limit allows to achieve a maximum utilization of the power unit’s output, resulting in optimized acceleration.

The control unit can derive the dynamic transmission protection torque component from the torque difference that is composed of the mass moments of inertia of the rotatable drive train components that are located upstream of the transmission in the torque flow direction, the magnitude of which depends on the actual acceleration of the vehicle. By calculating the dynamic protection torque component from real inertia values, precise and adaptive adjustment of the transmission protection limit is enabled. This improves the efficiency of the drive unit and ensures that the transmission remains optimally protected in various driving situations.

Advantageously, the control unit can have an assignment module that uses the torque difference directly as the dynamic transmission protection torque component. The direct use of the torque difference for determining the dynamic transmission protection torque ensures fast and precise adjustment of the protection limit. This means that unused torque can be better utilized, while at the same time ensuring protection of the components.

In a specific embodiment, the vehicle can have a rotational speed sensor that is arranged upstream of the transmission in the direction of torque flow. The rotational speed sensor can be used to detect an actual rotational speed gradient of the drive train. The control unit can have a calculation module that calculates the torque difference from the actual rotational speed gradient of the drive train and from the mass moments of inertia of the drive train components located upstream of the transmission. Precise measurement of the change in rotational speed by way of sensor technology makes the mass moment of inertia compensation even more accurate, which results in improved driving dynamics. The calculation logic ensures optimized control and an improved balance between protection and power utilization.

The disclosure can be used advantageously when the maximum drive torque that can be provided by the drive unit is greater than the static transmission protection torque component. In this way, the drive potential of the drive unit can be utilized as fully as possible without neglecting component protection in the transmission. This allows the full potential of the drive unit to be utilized, as torques exceeding the static limit can be temporarily released by the dynamic adjustment.

It should be emphasized that the maximum drive torque that can be provided by the drive unit does not necessarily have to be greater than the (variable) static transmission protection torque component. For example, the static transmission limit can be 825 Nm. The maximum engine torque can be 600 Nm. The torque converter multiplication factor can be 1.6 up to Gbx_max at 515 Nm < 600 Nm engine torque during start-up. In this case, the inertia compensation would also be effective even though the maximum engine torque is smaller than the static transmission protection torque if this is not defined as variable.

The control unit can deactivate the inertia compensation in the event of transmission shift operations, such as an upshift. This prevents the function of the dynamic torque increase from remaining active during these phases.

### BRIEF DESCRIPTION OF THE SEVERAL VIEWS OF THE DRAWINGS

An exemplary embodiment of the invention is described below with reference to the accompanying Figure in which a block circuit diagram of a drive train of a vehicle with an associated control unit is indicated in a roughly schematic view.

### DETAILED DESCRIPTION

The vehicle drive train shown in the figure is indicated only to the extent necessary for understanding the disclosure. Accordingly, the drive train has a drive unit 1 that can consist of one or more drive units, such as an internal combustion engine and/or an electric machine. For example, an output shaft 3 leads from the drive unit 1 to a dual-mass flywheel 5, from which a transmission input shaft 7 extends into a gearshift transmission 9 of the vehicle. A transmission output shaft 11 is drivingly connected to an axle differential 13 of a vehicle axle, from the output sides of which drive shafts lead to the vehicle wheels 15 of the vehicle.

As can be seen from the figure, an electronic control unit 17 controls the drive unit 1 with a target drive torque M_{Soll} on the basis of a driver-side setpoint input S. For this purpose, the electronic control unit 17 has a converter module 19 that converts the driver-side setpoint input S into the corresponding target drive torque M_{Soll}. The target drive torque M_{Soll} is limited to a maximum transmission protection torque limit M_{S}(a).

According to an embodiment of the invention, the transmission protection torque limit M_{S}(a) is not stored as a static value in the electronic control unit 17. Rather, the control unit 17 increases the transmission protection torque limit M_{S}(a) when an actual acceleration of the vehicle is present, while a static transmission protection torque component Mₛₜₐₜ is maintained when there is no such actual acceleration.

This is based on the fact that during vehicle acceleration, a transmission input torque M_{E} applied at a transmission input 21 is smaller than the target drive torque Mₛₒₗₗ, namely by a torque difference ΔM(a). This torque difference ΔM(a) is made up of the actual mass moments of inertia of the rotatable drive train components that are located upstream of the transmission 9 in the direction of torque flow, the magnitude of which depends on the actual acceleration of the vehicle. The torque difference ΔM(a) thus provides a margin within which the transmission protection torque limit M_{S}(a) can be adjusted, while at the same time ensuring sufficient component protection in the transmission 9. Due to the transmission protection torque limit M_{S}(a), which can be adjusted as a function of vehicle acceleration, the drive potential that can be provided by the drive unit 1 can be better utilized compared to a control unit 17 in which a static transmission protection torque limit is stored.

To provide the transmission protection torque limit M_{S}(a), the control unit 17 has a determination module 23, an assignment module 25, and an evaluation module 27. The determination module 23 is in signal connection with a rotational speed sensor 29 that detects the rotational speed and a rotational speed gradient (a) at the transmission input shaft 7. In addition, the control unit 17 in the figure has, by way of example, a database 31 in which the mass moments of inertia of the rotatable drive train components located upstream of the transmission 9 in the direction of torque flow are stored. Depending on the coupling or decoupling, this value of the effective mass moments of inertia must be adjusted, for example in the case of a decoupled internal combustion engine.

By way of example, the moment of inertia J₁ of the drive unit 1 and the moment of inertia J₂ of the dual-mass flywheel 5 are shown in the figure. Based on the mass moments of inertia J₁ and J₂ and the rotational speed gradient a, the determination module 23 calculates a torque difference ΔM(a). The transmission input torque M_{E} applied at the transmission input 21 is therefore smaller than the target torque M_{S} with which the control unit 17 controls the drive unit 1 by this torque difference ΔM(a).

As an alternative to the exemplary embodiment shown in the figure, the mass moment of inertia data does not have to be stored in the database 31 but can be received from other control units via the bus system.

According to the figure, the torque difference ΔM(a) is read into the assignment module 25. In the assignment module 25, the torque difference ΔM(a) is equated to a dynamic transmission protection torque component M_{dyn}. The dynamic transmission protection torque component M_{dyn} is supplied to the evaluation module 27. In the evaluation module 27, the transmission protection torque limit M_{S}(a) is calculated from the sum of the static transmission protection torque component Mₛₜₐₜ and the dynamic transmission protection torque component M_{dym}. The static transmission protection torque component Mₛₜₐₜ is read into the evaluation module 27 from a database 33 and corresponds to a protection torque up to which component protection in the transmission 9 is guaranteed.

Aspects of the various embodiments described above can be combined to provide further embodiments. In general, in the following claims, the terms used should not be construed to limit the claims to the specific embodiments disclosed in the specification and the claims, but should be construed to include all possible embodiments along with the full scope of equivalents to which such claims are entitled.

1. A vehicle comprising:
a drive train, a drive unit of which outputs a drive torque to vehicle wheels via a transmission; and
a control unit,
wherein the control unit determines a target drive torque (Mₛₒₗₗ) on the basis of a driver-side setpoint input (S_{V}) with which the control unit controls the drive unit,
wherein the target drive torque (Mₛₒₗₗ) determined in the control unit is limited to a maximum transmission protection torque limit (M_{S}(a)), and
wherein during vehicle acceleration a transmission input torque (M_{E}) applied at a transmission input is smaller than the target drive torque (Mₛₒₗₗ) by a torque difference (∆M(a)) that is composed of actual mass moments of inertia of rotatable drive train components located upstream of the transmission in a torque flow direction, and a magnitude of which depends on an actual acceleration of the vehicle, and
wherein the control unit has an evaluation module that adjusts the transmission protection torque limit (M_{S}(a)) as a function of the actual acceleration of the vehicle or of an actual rotational speed gradient (a) in the drive train correlated therewith, in particular the transmission protection torque limit (M_{S}(a)) is increased when there is an actual acceleration of the vehicle, and a static transmission protection torque component (Mₛₜₐₜ) is maintained when there is no actual acceleration of the vehicle.

2. The vehicle according to claim 1, wherein the transmission protection torque limit (M_{S}(a)) is summed up from the static transmission protection torque component (Mₛₜₐₜ) and a dynamic transmission protection torque component (M_{dyn}), and wherein the dynamic transmission protection torque component (M_{dyn}) is zero in the absence of vehicle acceleration, so that the transmission protection torque limit (M_{S}(a)) corresponds to the static transmission protection torque component (Mₛₜₐₜ), and/or that the dynamic transmission protection torque component (M_{dyn}) builds up only in the presence of vehicle acceleration.

3. The vehicle according to claim 2, wherein in the event of acceleration, the control unit measures the dynamic transmission protection torque component (M_{dyn}) such that the transmission input torque (M_{E}) applied at the transmission input is less than or equal to the static transmission protection torque component (Mₛₜₐₜ), and/or the static transmission protection torque component (Mₛₜₐₜ) is stored in the control unit and/or corresponds to a protection torque up to which component protection in the transmission is ensured.

4. The vehicle according to claim 2, wherein the control unit derives the dynamic transmission protection torque component (M_{dyn}) from the torque difference (∆M(a)) that is composed of the mass moments of inertia of the rotatable drive train components located upstream of the transmission in the torque flow direction, the magnitude of which depends on the actual acceleration of the vehicle.

5. The vehicle according to claim 4, wherein the control unit has an assignment module that uses the torque difference (∆M(a)) as the dynamic transmission protection torque component (M_{dyn}).

6. The vehicle according to claim 1, wherein the vehicle has a rotational speed sensor that is arranged upstream of the transmission in the direction of torque flow and detects an actual rotational speed gradient (a) of the drive train, and wherein the control unit has a calculation module that calculates the torque difference (∆M(a)) from the actual rotational speed gradient (a) of the drive train and from the mass moments of inertia (J) of the drive train components located upstream of the transmission.

7. The vehicle according to claim 1, wherein the maximum drive torque that can be provided by the drive unit is greater than the static transmission protection torque component (Mₛₜₐₜ).

8. The vehicle according to claim 1, wherein the control unit sets the transmission protection torque limit (M_{S}(a)) to the static transmission protection torque component (Mₛₜₐₜ) when transmission shift operations are present.
